(19) United States
(12) Patent Application Publication
(10) Pub. No.: US 2022/0229291 A1
(43) Pub. Date: Jul. 21, 2022

(54) CAMERA DEVICE AND METHOD FOR DETECTING AN OBJECT

(71) Applicant: SICK AG, Waldkirch (DE)

(72) Inventors: Klemens WEHRLE, Waldkirch (DE); Ralf PASKE, Waldkirch (DE)

(21) Appl. No.: 17/578,415

(22) Filed: Jan. 18, 2022

(30) Foreign Application Priority Data
Jan. 19, 2021 (DE) 10 2021 100 947.2

(51) Int. Cl. G02B 27/00; G02B 7/182; H04N 5/225; G06V 10/22; H04N 5/232; G06K 7/14

(52) U.S. Cl. CPC G02B 27/0081; G02B 7/182; H04N 5/2256; G06V 10/22; B65G 2203/041; H04N 5/23229; G06K 7/1443; B65G 2203/0216; H04N 5/2259

(57) ABSTRACT

A camera device is provided that comprises a camera having an image sensor for recording images of the objects and at least one first deflection element, and wherein the field of view of the camera has at least one first part field of vision with detection of the first deflection element and a second part field of vision with detection of the first deflection element. In this respect, the first deflection element is arranged such that a first perspective of the first part field of vision is a different one than a second perspective of the second part field of vision; the first part field of vision thus provides a different perspective of the object than the first part field of vision so that at least two sides of the object are simultaneously recorded by the image sensor.

The invention relates to a camera device and to a method for detecting an object in a stream of objects moved in a longitudinal direction relative to the camera device.

Cameras are used in a variety of ways in industrial applications to automatically detect object properties, for example for the inspection or for the measurement of objects. In this respect, images of the object are recorded and are evaluated in accordance without the task by image processing methods. An important use of cameras is the reading of codes. Objects with the codes located thereon are detected with the aid of an image sensor and the code regions are identified in the images and then decoded. Camera-based code readers also cope without problem with different code types than one-dimensional barcodes which also have a two-dimensional structure like a matrix code and provide more information. Typical areas of use of code readers are supermarket cash registers, automatic parcel identification, sorting of mail shipments, baggage handling at airports, and other logistic applications.

A frequent detection situation is the installation of the camera above a conveyor belt. The camera records images during the relative movement of the object stream on the conveyor belt and instigates further processing steps in dependence on the object properties acquired. Such processing steps comprise, for example, the further processing adapted to the specific object at a machine which acts on the conveyed objects or a change to the object stream in that specific objects are expelled from the object stream within the framework of a quality control or the object stream is sorted into a plurality of partial object streams. If the camera is a camera-based code reader, the objects are identified with reference to the affixed codes for a correct sorting or for similar processing steps. As a rule, the conveying system continuously delivers path-related pulses by an incremental encoder so that the object positions are known at all times, even with a changing conveying speed.

The image sensor of the camera can be configured as a line or as a matrix. The movement of the object to be sensed is used to successively assemble an image in that lines are arranged in a row or in that individual images are combined. In this respect, only one object side can always be detected from the respective perspective of the camera and an additional camera has to be used for every further reading side.

FIG. 9 shows a conventional installation where a camera 100 records an object 104 located on a conveyor belt 102 with its field of vision 106 from above, in a so-called top reading. Additional cameras 100a-b having corresponding fields of vision 106a-b installed beside the conveyor belt 102 are required for a side reading. FIG. 10 shows an alternative installation for a top reading using a deflection mirror 108. A more compact construction of the reading tunnel with a camera 100 attached more closely is possible in this manner. However, this does not change the fact that the camera 100 can only detect a single object side and two additional cameras would be required for a side reading.

It is conceivable to orient the camera such that two sides of the object can be detected after one another in the course of the conveying movement. In U.S. Pat. No. 6,484,066 B1, one camera observes the front surface and a side surface from a correspondingly oblique perspective and a second camera observes the rear surface and the other side surface. Respective mirrors extends the light path in a small construction space in accordance with the principle of FIG. 10 explained above. The oblique perspective results in distortion, however, that has to be compensated and that reduces the image quality.

DE 20 2013 009 198 U1 discloses a device for deflecting and for widening the field of vision of a camera. In this respect, a wider field of vision is recorded by mirrors correspondingly tilted with respect to one another in that part zones disposed next to one another are imaged over one another on the image sensor. An alternative mirror arrangement for a corresponding field of vision widening is presented in EP 2 624 042 A2. However, in both cases the fact of only a single perspective on the object is maintained; a plurality of camera still have to be used for a detection of a plurality of sides.

EP 0 258 810 A2 deals with the inspection of articles. Five or six sides are detectable with the same camera through a plurality of mirrors. The large number of mirrors results in a high adjustment effort and does not work with a line scan camera and the resolution accordingly remains limited for code reading, with code reading also not being a provided use. A whole group of illumination units is arranged around the article for the illumination. A detection of an object from a plurality of sides by a mirror arrangement is also known from U.S. Pat. No. 2,010,226 114 A1, with the comparable disadvantages being accompanied by the fact that no movement of the object is provided here.

Staggered mirrors are used in EP 2 937 810 A1 to effectively record an object multiple times at different distances. The object is thereby located in the light path via at least one of the mirrors in the depth of field range. In an embodiment, the mirrors are used to detect the front side, upper side, or rear side depending on the conveying position. A simultaneous detection of an object from a plurality of perspectives is, however, not possible in this manner and the side surfaces could still only be recorded using additional cameras.

US 2010/0163622 A1 uses a monolithic mirror structure in an optical code reader to spread the field of view of the image sensor over a plurality of different views. This mirror structure is complex and inflexible.

It is therefore the object of the invention to achieve an improved detection of objects moved in a stream.

This object is satisfied by a camera device and by a method for detecting an object in a stream of objects moved in a longitudinal direction relative to the camera device in accordance with the respective independent claim. A camera of the camera device records images of objects with an image sensor, said objects forming a stream of objects that is located in a relative movement to the camera in a longitudinal direction. At least one first deflection element provides a folding of the optical reception path for the image recording. The field of view of the camera is divided into at least one first part field of vision with detection of the first deflection element and a second part field of vision without detection of the first deflection element. In other words, the first deflection element can be seen in the first part field of vision and not in the second field of vision. More than two part fields of vision having different configurations of individual deflection elements or a plurality of deflection elements after one another can generally also be provided. It is conceivable that a part field of vision records the object completely without deflection and consequently directly. The part fields of vision are preferably disjunctive with respect to one another and thus correspond to different pixels and/or together form the total field of view of the image sensor or of the camera so that then all the pixels of the image sensor are utilized.

The invention starts from the basic idea of an expansion of the field of view of the camera by a different folding of the optical path, and indeed such that different perspectives of the object are produced beyond the original perspective. The first deflection element provides an additional perspective of the object in that it provides a fold at all in the first part field of vision and at least a different fold than in the second part field of vision. The recording of the objects from a plurality of perspectives using the same camera is thereby made possible. This recording takes place simultaneously from the different perspectives; differently, for example, than in EP 2 937 810 A1, where the front surface, upper surface, and rear surface can only be detected after one another in different conveying positions. The perspectives are moreover largely freely selectable, including a side detection.

This description is driven at many points by the idea of at least largely parallelepiped-shaped objects that have six sides or surfaces. This is also a frequent application, but the invention is not restricted to it, particularly since there are equally the corresponding six perspectives with objects of any desired geometry.

The invention has the advantage that a detection of a plurality of sides becomes possible with fewer cameras. The reduced number of camera reduces the costs and the complexity and enables a smaller and more compact mechanical system design. In this respect, the increasingly available high resolution of image sensors is used sensibly and as fully as possible.

The second perspective is preferably a plan view. The stream of objects is thus detected from above from the second perspective and the upper side of the objects is recorded; also called top reading with a code reader. The camera is in this respect preferably also installed above the stream. It is either itself downwardly oriented or the second perspective from above is provided by corresponding deflection elements. The first deflection element is not involved, it is outside the second part field of vision.

The first perspective is preferably a side view from a transverse direction transversely, in particular perpendicular, to the longitudinal direction. The first perspective, a lateral perspective in this embodiment, is produced by the deflection of the first deflection element. An object side is thus additionally detected, for example in addition to the upper side from the second perspective, with the second perspective alternatively also being able to record a first surface or a rear surface.

The camera device preferably comprises a second deflection element; the field of view of the camera has a third part field of vision with detection of the second deflection element and the second deflection element is arranged such that a third perspective of the third part field of vision is different than the first perspective and the second perspective so that three sides of the object can be simultaneously recorded by the image sensor. Analogously to the first perspective by the first deflection element, yet a third perspective is thus produced with a third part field of vision and a second deflection element. The second deflection element is accordingly detected exactly in the third part field of vision, accordingly not in the other part fields of vision, and the first deflection element not in the third part field of vision. The third perspective Is particularly preferably a side view from an opposite direction to the first perspective. Both sides of the object are thus recorded from the first and third perspectives, in addition to the second perspective of the upper side, for example.

The camera is preferably installed as stationary at a conveying device which conveys the stream of objects in the longitudinal direction. A preferred installation position is above the conveyor belt to thus combine a detection from above with the detection of one or more further sides, in particular with a lateral detection. Other installation positions are, however, also conceivable to combine other perspectives. If the lower side is to be detected, arrangements have to be made at the conveying device such as an inspection window.

The camera device preferably has a third deflection element that is arranged such that it is detected in the second part field of vision. The optical reception path is also folded in the second part field of vision or in the second perspective. An example is the orientation of the camera not directly toward the object, for instance a shallow direction of gaze at least approximately in parallel with or antiparallel to the longitudinal direction with a deflection onto the object from above or from a side. It is conceivable to fold the optical path of the second perspective multiple times by further deflection elements.

The camera device preferably has a fourth deflection element that once again folds the optical reception path of the first perspective folded by the first deflection element. The deflection for the first perspective accordingly has two or more stages, for example first from a camera installed above next to the stream and then on the object. The at least double deflection permits a detection of the object at least almost perpendicular to its surface to be recorded, in particular a side surface, in addition to a particularly compact design.

The camera device preferably has a fifth deflection element that once again folds the optical reception path of the third perspective folded by the second deflection element. The function of the fifth deflection element for the third perspective corresponds to that of the fourth deflection element for the first perspective.

The deflection elements are preferably arranged such that the light paths between the camera and the object are of the same length for the different perspectives with a tolerance corresponding to a depth of field range of the camera. Focused images are thereby recorded in all perspectives. An implementation option comprises affixing the third deflection element at a greater distance from the camera than the first or second deflection element. The light path in the second perspective is ultimately thereby artificially extended to compensate the diversion that is required in the first or third perspective. It thereby becomes possible that the light path from the camera via the third deflection element to the object, for example to its upper side, is approximately the same length as that from the camera via the first deflection element and the fourth deflection element to the object, for example its side surface, or correspondingly from the camera via the second deflection element and the fifth deflection element to the object, for example to its other side surface.

The respective deflection elements preferably have a mirror and a holder for installation in a specified arrangement and orientation with respect to the stream of objects. Due to their own holders and as separate components, the deflection elements can be positioned and oriented largely optionally in space, completely differently than, for example, with a monolithic mirror structure in accordance with US 2010/0163622 A1 named in the introduction. The mirrors can satisfy further optical functions, for instance by curved mirror surfaces having bundling or scattering properties or can be provided with filtering properties for specific spectra by coatings and the like.

The image sensor is preferably configured as a linear sensor, however. Such linear sensors are available with very high pixel resolutions that are actually no longer absolutely necessary in part for the detection of a single object side. In accordance with the invention, the additional pixels can be used to record additional sides from additional perspectives.

Pixel regions of the image sensor disposed next to one another preferably correspond to the part fields of vision, in particular a central pixel region to the second part field of vision and a side pixel region to the first or further part fields of vision. The width of the field of vision is then preferably greater than that of the stream of objects to be detected or of the conveyor belt and a lateral excess is advantageously used at one side or at both sides for a further perspective or for two further perspectives.

Alternatively, pixel regions of the image sensor disposed above one another correspond to the part fields of vision. In this case, the image sensor is a matrix sensor whose linear sections disposed above one another are used for the different perspectives. For this purpose, the deflection elements are preferably formed with a plurality of correspondingly tilted sections or additional deflection elements are used to arrange the part fields of vision suitably on the matrix sensor.

The camera device preferably has an illumination unit to illuminate the field of view of the camera, in particular the part fields of vision via the respective deflection elements. If the illumination unit likewise uses the deflection elements, a single central illumination unit is sufficient, wholly analogously to a single image sensor that can record from a plurality of perspectives in accordance with the invention.

The camera device preferably has a control and evaluation unit that is configured to localize code regions in the image data detected by the image sensor and to read their code content. Code contents can be detected in a further sense as in the reading of texts (OCR, optical character reading) or the recognizing of symbols. A camera-based code reader is, however, particularly preferably meant that reads optical barcodes and optical 2D codes and that does this with a single camera and a single image sensor from a plurality of object sides simultaneously.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

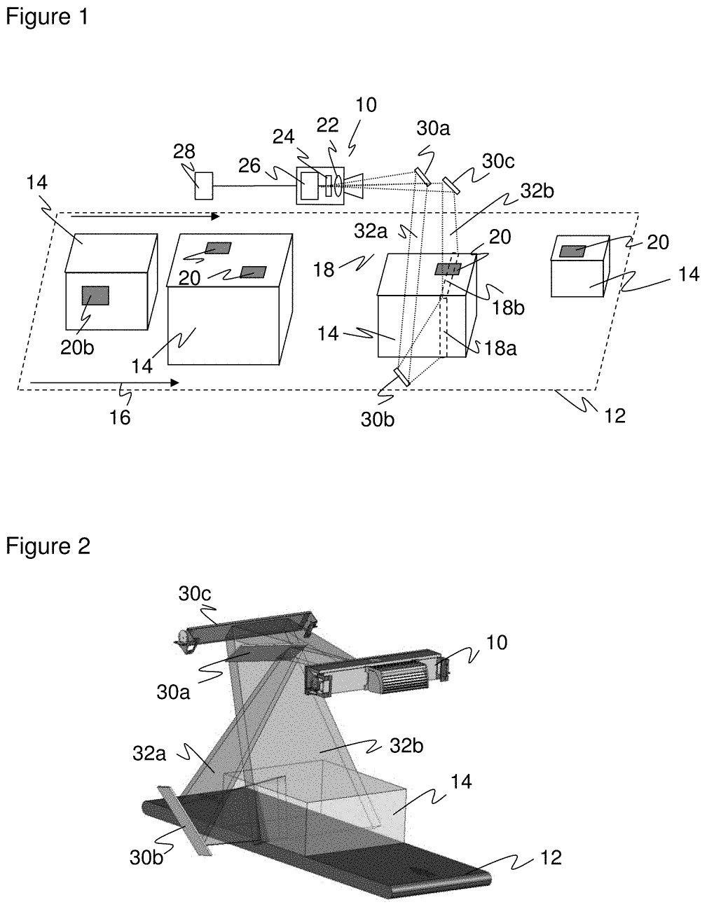

FIG. 1: a schematic view of a camera installed at a conveyor belt with objects to be detected;

FIG. 2 a three-dimensional view of a camera device with folded optical paths for a simultaneous detection from above and from one side;

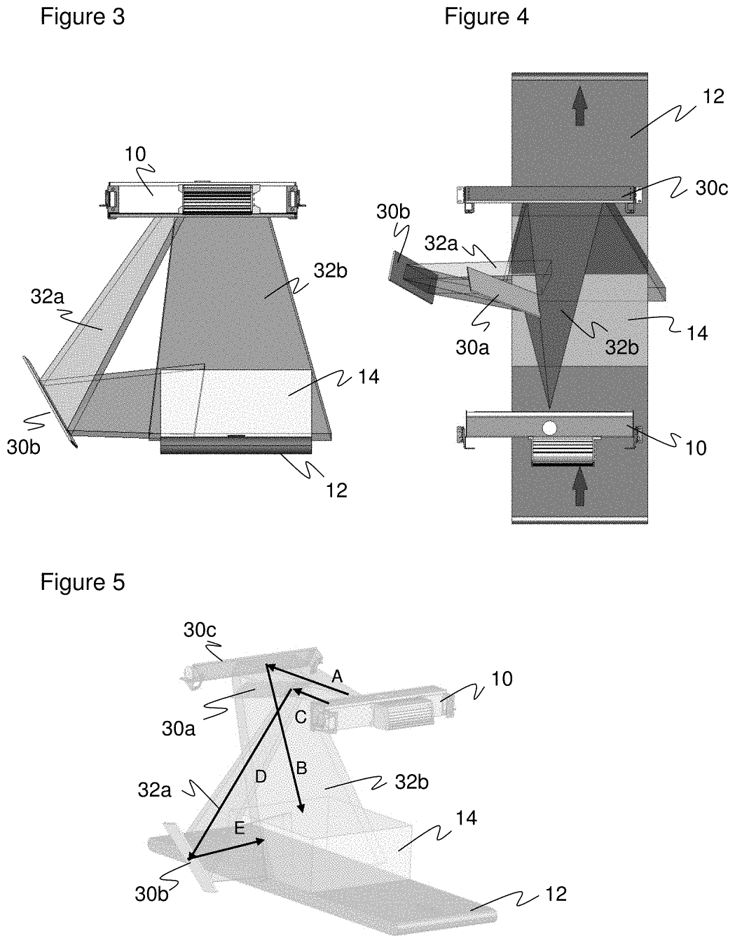

FIG. 3 a front view of the camera device in accordance with FIG. 2;

FIG. 4 a plan view of the camera device in accordance with FIG. 2;

FIG. 5 a dissection of the light paths in FIG. 2 to explain how the object can be held by light paths of equal length for all the perspectives in the depth of field range;

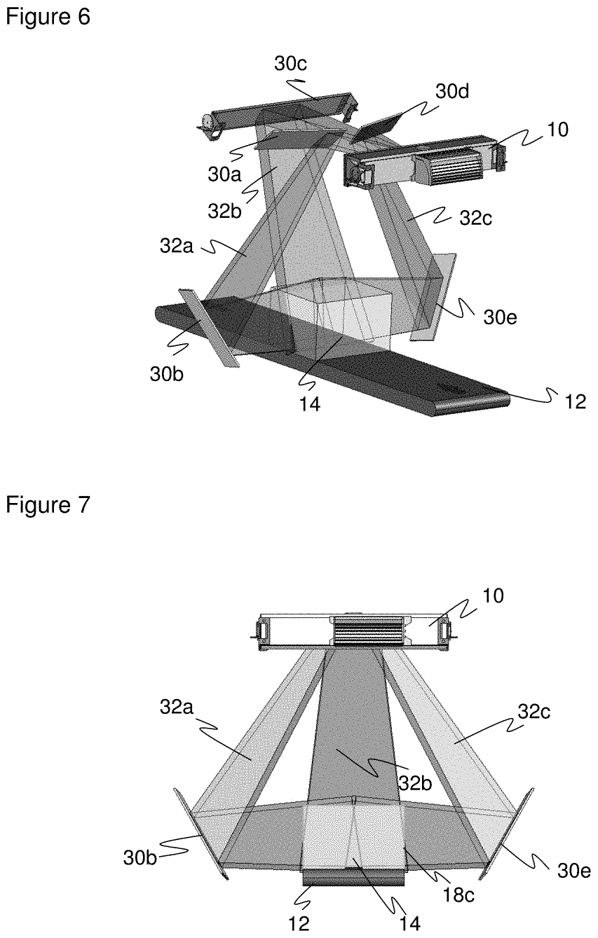

FIG. 6 a three-dimensional view of a camera device with folded optical paths for a simultaneous detection from above and from both sides;

FIG. 7 a front view of the camera device in accordance with FIG. 6;

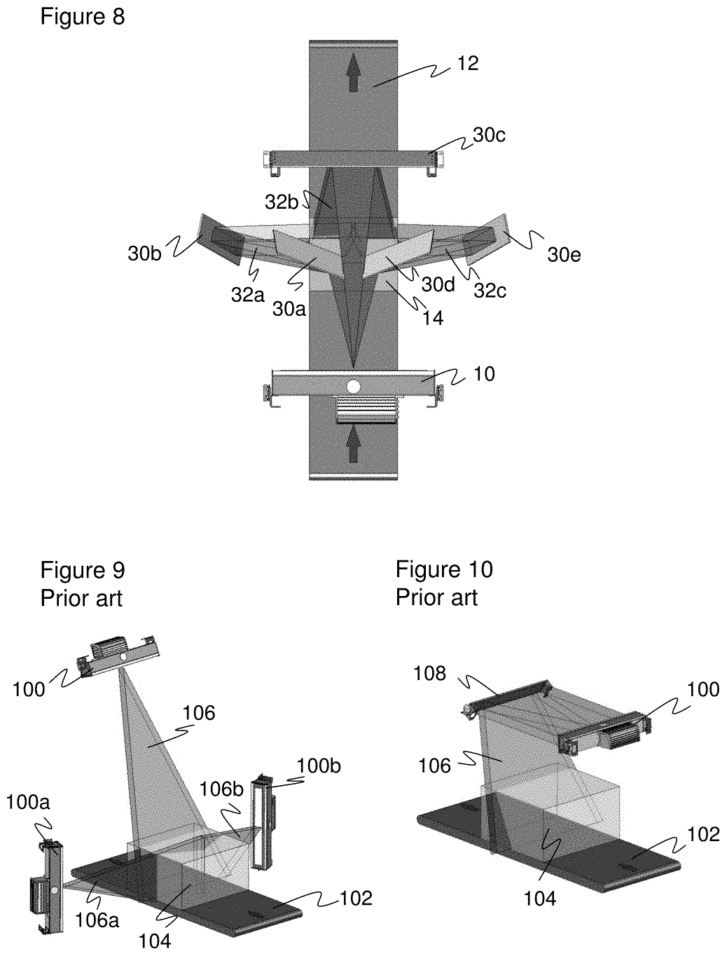

FIG. 8 a plan view of the camera device in accordance with FIG. 6;

FIG. 9 a representation of a conventional camera device that requires three cameras for the detection of three sides; and

FIG. 10 a representation of a further conventional camera device that detects an object from above with the aid of a mirror with a horizontal orientation.

FIG. 1 shows a camera 10 that is mounted above a conveyor belt 12 on which objects 14 are conveyed through a field of vision 18 of the camera 10 in a conveying direction 16 indicated by arrows. The objects 14 bear codes 20 that are read by the camera 10 at their outer surfaces in a preferred embodiment. For this purpose, the camera 10 records images of the respective objects 14 located in the field of vision 19 via a reception optics 22 using an image sensor 24.

An evaluation unit 26 comprises a decoding unit that evaluates the images. In this respect, code regions are identified and the code contents of the codes 20 are read. The evaluation function can also be implemented at least partially outside the camera 10. The camera 10 is only preferably configured as a camera-based code reader. In addition to the reading of optically 1 D or 2D codes, further possible image processing work includes the recognition of symbols, in particular Hazmat labels, the reading of characters (OCR, optical character reading), in particular of addresses, and further processing.

The camera 10 can be configured as a line scan camera having a linear image sensor 24 of preferably a high resolution of, for example, eight thousand or twelve thousand pixels. Alternatively, the image sensor 24 is a matrix sensor that can have a total comparable resolution overall of four, eight, or twelve megapixels. However, they are distributed over the surface so that a successive image recording with a line in the course of the conveying movement can result in substantially more highly resolved images. In some applications, in particular when using image processing on the basis of machine learning or CNNs (convolutional neural networks), a smaller pixel resolution is also sufficient. A static image recording without a moved object stream or a conveyor belt 12 is generally also conceivable with a matrix sensor. Conversely, it is often sensible also to combine the images recorded by a matrix sensor successively to a larger image in the course of a conveying movement.

Further sensors that are shown as representative by a feed sensor 28, for example an incremental encoder, by which the speed or the feed of the conveyor belt 12 is determined, can belong to a reading tunnel formed by a camera 10 and a conveyor belt 12. Information that is detected at some point along the conveyor belt 12 can thereby be converted at different positions along the conveyor belt 12, or, which is of equal value thanks to the known feed, at different times. Further conceivable sensors are a trigger light barrier that respectively recognizes the entry of an object 14 into the field of vision 18 or a geometric sensor, in particular a laser scanner, that detects a 3D contour of the objects 14 on the conveyor belt 12.

The field of vision 18 of the camera 10 is divided by deflection elements 30a-c, in particular mirrors, and the respective optical reception path 32a-b is correspondingly folded. This will become more easily recognizable and will be explained in more detail with reference to FIGS. 2 to 8. Deflection elements 30a, 30b provide that the optical reception path 32a is folded on one side of the object 14. The other optical reception path 32b is deflected by means of a deflection element 30c from a perpendicular extent on the upper side of the object 14 into the horizontal corresponding to the alignment of the camera 10.

Part fields of vision 18a-b are thereby produced on the surface and on a side surface of the object 14 so that two sides of the object 14 are detectable at the same time. The part fields of vision 18a-b in FIG. 1 are linear for a successive line-wise detection of the object 14 in the course of the conveying movement; with a matrix sensor as the image sensor 24, correspondingly wider part vision fields are produced.

Different pixel regions or image segments are also produced on the image sensor 24 due to the division of the field of vision 28 into part fields of vision 18a-b. With a line sensor, these image segments are preferably simply disposed next to one another. Accordingly part zones of the reading field not required for the central part of the detection and optionally also their illumination are decoupled and are used for the detection of an additional side by deflections or folding. With a matrix sensor, part fields of vision 18a-b can likewise be arranged next to one another, but also stripwise above one another on the image sensor 24.

An optional active illumination of the camera 10 not shown in FIG. 1 can likewise be folded via the deflection elements 30a-c as an illumination coaxial to the image sensor 24. A central illumination at the location of the camera or integrated therein is thus sufficient and the respective part fields of vision 18a-b are illuminated thereby.

The recorded images can be prepared in the evaluation unit 26 or in a downstream image processing using parameters adapted to the part fields of vision 18a-b. Equally, parameters of the image sensor 24 or of the illumination can be set or regulated sectionally. The contrast or brightness is thereby adapted, for example. A beam-shaping or optical filtering, in particular by a corresponding coating, by the deflection elements 30a-c is also conceivable.

FIG. 2 shows the camera device in accordance with FIG. 1 again in a three-dimensional view. FIGS. 3 and 4 are additionally an associated front view in the conveying direction and a plan view. The camera 10 is aligned horizontally or in parallel with the conveyor belt and is alternatively also aligned against the conveying direction. A lateral optical reception path 32a is guided or folded laterally via an upper deflection element 30a at the left side, first to the bottom next to the conveyor belt 12 and then via a lower deflection element 30b at the left side in as perpendicular a manner as possible onto the side surface of the object 14. The lateral optical reception path 32a corresponds to the part field of vision 18a not separately designated in FIG. 2 for reasons of clarity. The upper deflection element 30a at the left side on its own, that is without a lower deflection element at the left side, could already alternatively deflect to the side surface, but then with an oblique and no longer perpendicular optical path. A central optical reception path 32b is deflected downwardly to the upper side of the object 14 at a central deflection element 30c. The central optical reception path 32b corresponds to the part field of vision 18b no longer separately designated here.

Thanks to the deflection elements 30a-c and the correspondingly folded optical reception path 32a-b, the upper side and the left side of the object 14 can be simultaneously detected from two different perspectives by the camera 10. It is understood that this would alternatively equally be able to be transferred to the right side. The detection of two sides is anyway admittedly particularly advantageous for the case of a first perspective from the side and of a second perspective from above, but a detection of two other sides or surfaces of the object 14 or two different perspectives than from above and from the side would be equally conceivable.

FIG. 5 again shows the representation of FIG. 2 as a background and divides the optical reception paths 32a-b therein into their straight-line part sections A-E. The camera 10 with its reception optics 22 only has a limited depth of field range. It is therefore particularly advantageous if the light paths are of equal lengths for the different perspectives. Respective focused images are thereby recorded of the simultaneously detected sides of the object 14. Differences in the light path lengths, particularly when they go beyond the tolerance that a finite depth of field range permits, would in contrast produce blur in the recording of at least one side or surface. The same length of the optical reception paths 32a-b can be ensured by a skillful arrangement of the deflection elements 30a-c, that is the equation A+b=C+D+E could specifically be satisfied. For this purpose, the central deflection element 30c is arranged further away from the camera 10 with respect to the upper deflection element 30a at the left side so that A and B are extended, and indeed by just so much as corresponds to the diversion by the double deflection onto the side surface having the sections C, D, E. It must be repeated that approximate identity within the framework of the depth of field range is sufficient.

The camera 10 can have an adjustable focus or an autofocus instead of a fixed focus. However, this alone does not solve the problem of blur from different perspectives since the depth of field range can thus only be adapted for one perspective. Another option of solving the focusing problem is a combination with the teaching of EP 2 937 810 A1 named in the introduction. In this respect, deflection elements 30a-c are suitably replaced with staggered deflection elements at different distances. The recorded image sections multiply in accordance with the staggering and a respective image section is localized and further processed that has been recorded with a suitably long light path in the depth of field range.

FIG. 6 shows a further embodiment of the camera device in a three-dimensional view, with FIGS. 7 and 8 as a supplementary associated front view in the conveying direction or as a plan view. Unlike the embodiment in accordance with FIGS. 2 to 6, the other side of the object 14 is now also detected from an additional third perspective. The above statements apply analogously with respect to the different embodiment options and in particular the configuration of the light paths for a respective recording in the depth of field range. This also in particular applies to a configuration with equally long light paths corresponding to FIG. 5, i.e. the detection of the other side of the object 14 should likewise preferably take place with a light path of equal length.

To provide a third perspective and to also still detect the second side of the object 14, at the right here observed in the conveying direction 16, an additional decoupling of a further lateral optical reception path 32c takes place laterally via an upper deflection element 30d at the right side, first downward next to the conveyor belt 12 and then via a lower deflection element 30a at the right side in as perpendicular a manner as possible to the other side surface of the object 14. The further lateral optical reception path 32c corresponds to an additional part field of vision 18c only designated in FIG. 7 for reasons of clarity. Two part fields of vision 18a, 18c are now therefore decoupled at both sides of the central part field of vision 18b. Thanks to the deflection elements 30a-e and the correspondingly folded optical reception paths 32a-c, the upper side, the left side, and the right side of the object 14 can be simultaneously detected from three different perspectives by the camera 10. Instead of a detection from above and from both sides, three other perspectives of a different combination of sides of the object 14 would be conceivable.

If the deflection does not take place in a perpendicular manner on the lateral surfaces, as previously described, but rather within the horizontal plane at a 45° angle, that is, so-to-say on a perpendicular edge of an object 14 imagined as parallelepiped-shaped, the front surface or back surface can also be detected after one another in the course of the conveying movement with the respective side. In the embodiment in accordance with FIGS. 2 to 5, a decision would have to be made on the front surface or the rear surface or to cover the respectively not detected surface via the perspective from above by a corresponding tilting. In the embodiment in accordance with FIGS. 6 to 8, the one side can be detected at the front surface and the other side at the rear surface. However, the disadvantage of a no longer perpendicular perspective on the respective object surface has to be accepted for this purpose.

1. A camera device for detecting an object in a stream of objects moved in a longitudinal direction relative to the camera device, wherein the camera device comprises a camera having an image sensor for recording images of the objects and at least one first deflection element, wherein the field of view of the camera has at least one first part field of vision with detection of the first deflection element and a second part field of vision without detection of the first deflection element, and wherein the first deflection element is arranged such that a first perspective of the first part field of vision is a different one than a second perspective of the second part field of vision; the first part field of vision thus provides a different perspective of the object than the first part field of vision so that at least two sides of the object are simultaneously recorded by the image sensor.

2. The camera device in accordance with claim 1,
wherein the second perspective is a plan view.

3. The camera device in accordance with claim 1,
wherein the first perspective is a side view from the transverse direction transverse to the longitudinal direction.

4. The camera device in accordance with claim 1,
that comprises a second deflection element, wherein the field of view of the camera has a third part field of vision with detection of the second deflection element and the second deflection element is arranged such that a third perspective of the third part field of vision is a different one than the first perspective and the second perspective so that three sides of the object are simultaneously recorded by the image sensor.

5. The camera device in accordance with claim 4,
wherein the third perspective is a side view from an opposite direction from the first perspective.

6. The camera device in accordance with claim 1,
wherein the camera is installed as stationary at a conveying device which conveys the stream of objects in the longitudinal direction.

7. The camera device in accordance with claim 1,
that has a third deflection element that is arranged such that it is detected in the second part field of vision.

8. The camera device in accordance with claim 1,
that has a fourth deflection element that once again folds the optical reception path of the first perspective folded by the first deflection element.

9. The camera device in accordance with claim 4,
that has a fifth deflection element that once again folds the optical reception path of the third perspective folded by the second deflection element.

10. The camera device in accordance with claim 1,
wherein the deflection elements are arranged such that the light paths between the camera and the object are of the same length for the different perspectives with a tolerance corresponding to a depth of field range of the camera.

11. The camera device in accordance with claim 1,
wherein the deflection elements have a mirror and a holder for installation in a specified arrangement and orientation with respect to the stream of objects.

12. The camera device in accordance with claim 1,
wherein the image sensor is configured as a line sensor.

13. The camera device in accordance with claim 1,
wherein pixel regions of the image sensor disposed next to one another correspond to the part fields of vision.

14. The camera device in accordance with claim 13,
wherein a central pixel region corresponds to the second part field of vision and a lateral pixel region corresponds to further part fields of vision.

15. The camera device in accordance with claim 1,
wherein pixel regions of the image sensor disposed above one another correspond to the part fields of vision.

16. The camera device in accordance with claim 1,
that has an illumination unit to illuminate the field of view of the camera, in particular the part fields of vision via the respective deflection elements.

17. The camera device in accordance with claim 1,
that has a control and evaluation unit that is configured to localize code regions in the image data detected by the image sensor and to read their code content.

18. A method of detecting an object in a stream of objects moved in a longitudinal direction, wherein images of the object are recorded in a field of view and the field of view has a first part field of vision with detection of a first deflection element and a second part field of vision without detection of the first deflection element, and wherein the first deflection element is arranged such that a first perspective of the first part field of vision is a different one than a second perspective of the second part field of vision; the first part field of vision thus provides a different perspective of the object than the second part field of vision so that at least two sides of the object are simultaneously recorded by the image sensor.
